(19) United States
(12) Patent Application Publication
(10) Pub. No.: US 2019/0265755 A1
(43) Pub. Date: Aug. 29, 2019

(54) Laptop Case With Movable Attached Platform

(71) Applicant: Ali A. Mohamed, Lynn Haven, FL (US)

(72) Inventor: Ali A. Mohamed, Lynn Haven, FL (US)

(21) Appl. No.: 15/904,431

(22) Filed: Feb. 26, 2018

(51) Int. Cl. G06F 1/16; A47B 23/04; A45C 13/00

(52) U.S. Cl. CPC G06F 1/1628; A47B 23/044; A45C 2011/003; G06F 1/1616; A45C 13/002

(57) ABSTRACT

A laptop case with a movable attached platform to either of the short sides of the case, left or right, or to both of the short sides of the case, that initially sit(s) within the case when folded or within the top or bottom housing(s) of the case when in the resting position, and lay(s) flat directly beside the case when unfolded or when slid out in the use position. This/these platform(s) can be used to hold a variety of electronics and media, including but not limited to tablet and handheld devices, portable gaming and electronic devices, notebooks and writing pads, and books and magazines for use while sitting, reclining, or standing.

### 1. TECHNICAL FIELD

This invention relates to laptop carrying cases, platforms, and structures that support documents, books, working tools, and other objects on the lap of a user and, more particularly, to a portable device being a laptop carrying case that provides an easy and comfortable presentation of supported articles by the use of (a) built-in movable platform(s).

### 2. BACKGROUND AND DESCRIPTION OF THE RELATED ART

### Laptops

Computers first became portable by combining the computer, monitor and keyboard into a single unit. The first portable computers were created in the late 1970's. None of these early prototypes were ever marketed to the public. The first portable computers did not become commercially available until seven years later, in 1983. Early laptops were not convenient to transport because of their size and weight. It was not until the late 1980's that laptops became lightweight and compact enough to be convenient to transport. Since that time, laptops have become more lightweight and their components have become smaller, allowing for skinnier and smaller transport devices' designs.

### Laptop Cases

As laptops have become increasingly lightweight, their portability has increased dramatically, which has led to the advent of the laptop case. The primary purpose of the laptop case is to carry a laptop, which increases its portability. The two important secondary purposes are to protect the laptop from damage and to provide security from theft. Laptop cases vary greatly in how well they succeed in those secondary purposes.

Laptop cases typically are padded to reduce bumps, scratches and drops to the laptop while it is being transported. Most laptop cases are also manufactured from water resistant or waterproof materials and are designed to hold the laptop somewhat isolated from the surrounding environment. Laptop cases vary dramatically in size and storage space. Some cases only have room for the laptop itself. Most cases, at a minimum, have storage capacity for the laptop's power cable. Larger cases have room for a substantial array of accessories and documents, thus serving the dual role of laptop case and briefcase. A laptop case commonly comprises of a case for holding the laptop and a carrying means, which is generally a shoulder strap and/or a handle. The past few years have seen an explosion in the types of laptop carrying devices which have become commercially available. The two common styles of laptop bags are shoulder bags and backpack-style bags. The options include simple laptop sleeves, backpacks, totes, messenger bags and briefcases. The materials are usually leather, cloth, aluminum, nylon, polypropylene and/or other polymers.

Novelty laptop bags have established a marketing niche and set themselves apart from the more common types of laptop bags. The minimalist version of a laptop carrying device on the market is not a bag at all. It is a looped shoulder strap that is used to carry a laptop. A length of the strap is placed above the keyboard of an open laptop, so that when the laptop is closed, the laptop can be carried by the strap. The strap is marketed as a quick way to take a laptop through airport security.

Another unusual laptop case design is a cardboard laptop case made from a pizza box lined with foam. This design's primary purpose is to reduce the risk of theft by disguising the laptop. “Green” laptop cases made of recycled cardboard or carpet strips are also being marketed. Recently, a Japanese company has entered the high end market with a wooden laptop case.

### Briefcases

A briefcase is a box-type case that opens into two hinged compartments, much like a small suitcase. Briefcases often comprise of a lock, increasing their security in comparison to other types of bags. Traditionally, leather or vinyl was stretched over a rigid frame to create a hard-sided briefcase. More recently, briefcases have also been manufactured from plastics, rigid polymers and aluminum, as well as leather.

The traditional hard-sided rectangular briefcase provides protection and security for its contents and is ideal as a carrying case for a laptop. The only real drawback of the hard-sided briefcase is the potential resulting weight of the laptop and the case. As laptops have gotten lighter, the use of impact-resistant briefcases as laptop cases has become feasible.

### Portable Tables and Stands

There are multiple stands on the market. Some are capable of carrying a laptop and combine the feature of being both a laptop case and a portable laptop stand, while others are more stationary and are not portable and/or are incapable of carrying a laptop.

### Lap Desks

Lap desks have long existed to hold media and other objects. These include breakfast trays, book frames, writing desks, wedges, bean bag pillows, etc. These units have been designed to be used either on or above users' laps. Most lap desks offer a single flat or angled surface to support objects, such as books, documents, and the like.

These different inventions differentiate from the present invention in several ways. They all lack at least one of the combined features of the present invention. These features include the ability to be lightweight, slim, portable, and the ability to function as a laptop carrying case, and provide a platform for utility.

### BRIEF SUMMARY OF THE INVENTION

The present invention combines the structural features and functionality of a laptop case and a lap desk or table into a single slim easily portable lightweight unit. The present invention consists of a laptop case with a movable attached platform to either of the short sides of the case, left or right, or to both of the short sides of the case, that initially sit(s) within the case when folded or within the top or bottom housing(s) of the case when in the resting position, and lay(s) flat directly beside the case when unfolded or when slid out in the use position. The exterior housing of the laptop case consists of either a hard durable material, or a softer fabric or fabric-like material. The interior of the laptop case housing consists of either a fabric or fabric-like soft material or any other material that provides protection to a laptop sitting within the case. The movable attached platform(s) consist(s) of a hard durable material that can support a variety of electronics and media. This/these platform(s) is/are attached to the case either continuously with a structurally durable material that can fold in on itself or directly, using a hinge or any other connecting device between the platform and either directly with or inside the laptop case or to another similar durable structure integrated into the bottom of the laptop case at either the left or right short side of the case.

It is a primary objective of the present invention to combine the functionality of a lap desk or table with the convenience and portability of a laptop case, resulting in a single device that can protect and transport a laptop and obviate the need for a table or separate laptop stand.

### BRIEF DESCRIPTION OF DRAWINGS

NOTE: For simplicity of drawings, zippers, hinges, and other laptop case and platform components may be omitted from some or all of the drawings as they are obvious and known to those with skill in the art. When they are shown, it is purely for illustrative purposes and not intended to capture all embodiments of the invention disclosed. Please also note that drawings of hinges are purely for demonstrative purposes of the mechanism of the disclosed invention and are not solely the type or the only type of hinge or connecting device that is used for this invention. Platform size and case size may also lack proportionality as again, these drawings are only for demonstrating how the disclosed invention functions and how it may roughly look.

FIG. 1 is a display of a top and perspective view of the laptop case open with the movable attached platform unfolded and in the use position, respectively.

FIG. 2 is a display of a top and perspective view of the laptop case with the movable attached platform opening and closing respectively with a flap or flap-like mechanism.

FIG. 3 is a top view of the laptop case open with the movable attached platform opening and closing respectively with a sliding or sliding-like mechanism.

### DETAILED DESCRIPTION OF THE INVENTION

The various embodiments and variations thereof illustrated in the accompanying Figures and/or described herein are merely exemplary and are not meant to limit the scope of the invention. It is to be appreciated that numerous variations of the invention have been contemplated as would be obvious to one of ordinary skill in the art with the benefit of this disclosure. Rather, the scope and breath afforded this document should only be limited by the claims provided herein while applying either the plain meaning to each of the terms and phrases in the claim or the meaning clearly and unambiguously provided in this specification.

### Terminology

The terms and phrases as indicated in parenthesis (“ ”) in this section are intended to have the meaning ascribed to them in this section applied to them throughout this document including the claims unless clearly indicated otherwise in context.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases mean that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

The term “couple”, “coupled”, “connected”, “joined”, “welded”, “glued”, “attached” or “fixed” as used in this specification and the appended claims refers to either an indirect or direct connection between the identified elements, components or objects. Often the manner of the coupling will be related specifically to the manner in which the two coupled elements interact.

An Embodiment of a Unique Laptop Case with a Movable Attached Platform:

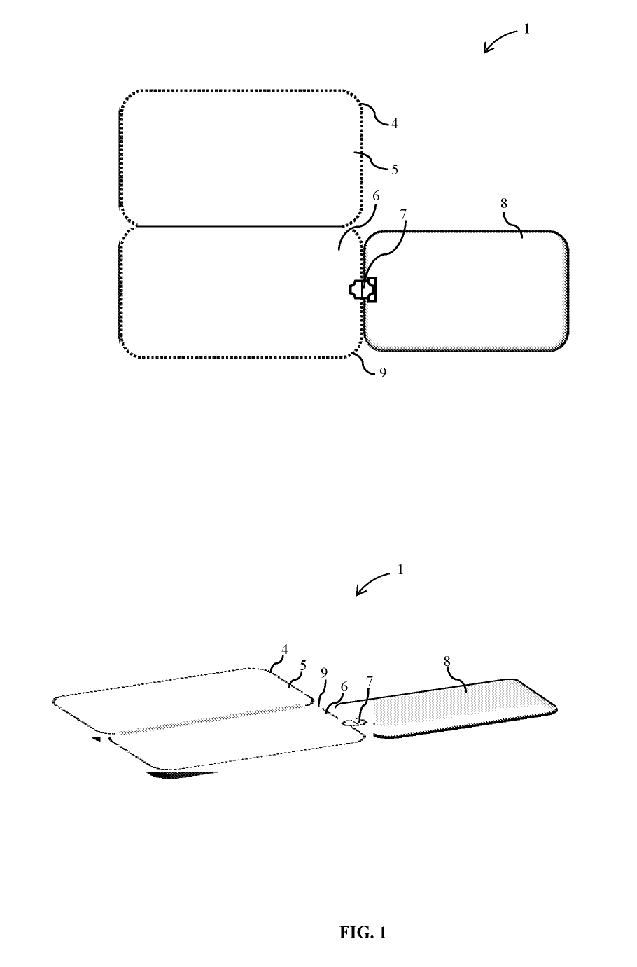

An embodiment of a laptop case with a movable attached platform in the open position 1 is illustrated in FIG. 1. In this embodiment, the laptop case is generally characterized by a bottom covering 6 that would line the base of a laptop and a top covering 5 that functions as a flap that mimics the motion of the opening of a laptop. A zipper runs continuously along the edge of both flaps with the top half of the chain 4 on the top flap 5 and the bottom half of the chain 9 on the bottom flap 6. A platform 8 is attached to the bottom covering of the case 6 using a hinge or other connecting device 7, either being integrated in the platform or case or not, whether it being consistent with the platform 8 or not, providing a durable, stable, and convenient surface for the holding of various electronics, types of media, and the like.

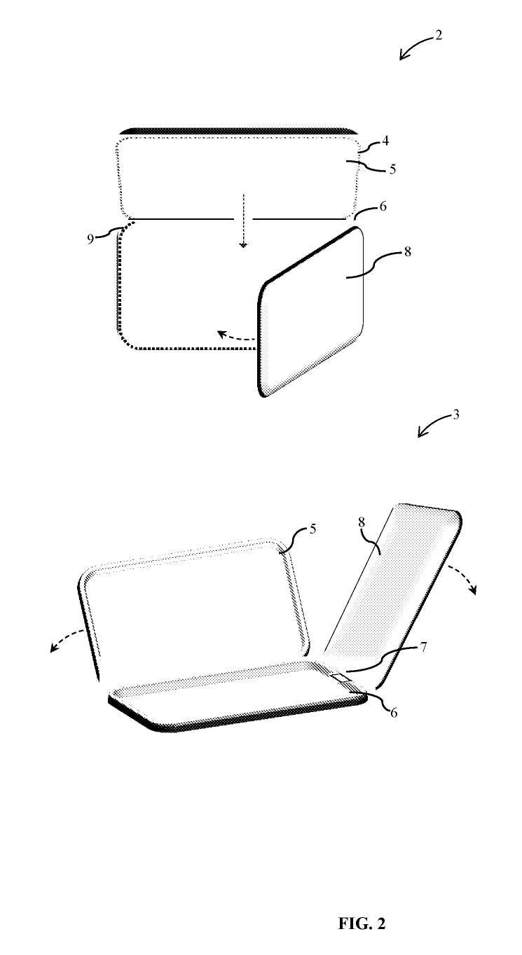

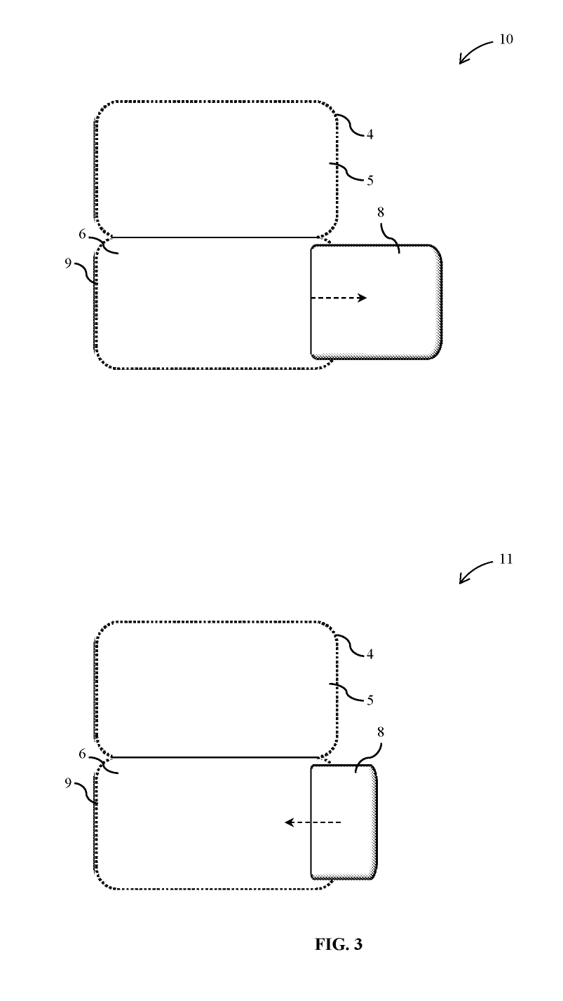

An embodiment of a laptop case with a movable attached platform in the closing position using a flap or flap-like mechanism 2 and an embodiment of a laptop case with a movable attached platform in the opening position using a flap or flap-like mechanism 3 are illustrated in FIG. 2. In this figure, dashed lines with arrows attached to one end represent movement of the object at the origin of the line to the head of the arrow in the direction of the arrow. Dashed lines with stealth arrows attached to an end represent movements that happen first and dashed lines with closed triangle arrows at an end represent movements that happen next. Dashed lines with stealth arrows at an end are used as needed to represent more than one movement occurring at the same time. The laptop case in FIG. 2 is the same as the laptop case in FIG. 1 but at a different functional position, therefore being generally characterized the same way as described above for the embodiment present in FIG. 1. An embodiment of a laptop case with a movable attached platform in the closing position using a sliding or sliding-like mechanism 11 and an embodiment of a laptop case with a movable attached platform in the opening position using a sliding or sliding-like mechanism 10 are illustrated in FIG. 3. The laptop case in FIG. 3 is also the same laptop case in FIG. 1 but adopting a different platform reveal mechanism, therefore being generally characterized the same way as described above for the embodiment present in FIG. 1.

The invention claimed is:

1. A laptop case with a movable attached platform comprising: a. general standard and obvious housing of a laptop case consisting of a consistent or inconsistent top and bottom layer joined together, when the laptop case is closed, by either a zipper, Velcro, or by any other connecting material, mechanism, or device, whether it being consistent with the laptop case housing or not, b. a firm durable platform that is attached to the laptop case continuously with a structurally durable material that can fold in on itself or directly using a hinge or other connecting device or mechanism integrated into the platform or case, or between the platform and either directly with the laptop case or to another similar durable structure integrated into the bottom of the laptop case at either the left or right short side of the laptop case, whereby the movable attached platform can be used to hold a variety of electronics and media, including but not limited to tablet and handheld devices, portable gaming and electronic devices, writing pads and notebooks, and books and magazines for use while sitting, reclining, or standing and can be replaced to sit within the laptop case when not in use.

2. A laptop case with a movable attached platform according to claim 1 whereby two movable platforms are attached.

3. A laptop case with a movable attached platform according to claim 1 whereby the platform follows a sliding mechanism from within the bottom or top housing of the laptop case as opposed to an outward flap or flap-like motion.

4. A laptop case with a movable attached platform according to claim 2 whereby the two platforms follow a sliding or slide-like mechanism from within the bottom and/or top housing of the laptop case as opposed to an outward flap or flap-like motion.

5. A laptop case with a movable attached platform according to claim 1 whereby additional platforms can unfold from the prior.

6. A laptop case with a movable attached platform according to claim 3 whereby additional platforms can unfold from the prior.

7. A laptop case with a movable attached platform according to claim 3 whereby additional platforms can slide out of or from the prior.

8. A laptop case with a movable attached platform according to claim 1 whereby additional platforms can slide out of or from the prior.

9. A laptop case with a movable attached platform according to claims 5, 6, 7, and 8 whereby two movable platforms are attached.
